(19) United States
(12) Patent Application Publication
(10) Pub. No.: US 2025/0356604 A1
(43) Pub. Date: Nov. 20, 2025

(54) AUTOMATED PROCEDURAL GENERATION OF 3D ASSETS THROUGH GEOMETRIC VARIATIONS USING SHAPE ANALYSIS AND SHAPE SYNTHESIS

(71) Applicant: Sony Interactive Entertainment Inc., Tokyo (JP)

(72) Inventor: Chockalingam Ravi Sundaram, San Mateo, CA (US)

(21) Appl. No.: 18/665,985

(22) Filed: May 16, 2024

(51) Int. Cl. G06T 19/20; G06T 7/60

(52) U.S. Cl. CPC G06T 19/20; G06T 7/60; G06T 2219/004; G06T 2219/2024

(57) ABSTRACT

A machine learning (ML) pipeline works solely on 3D assets without any meta data such as part labels or part structure or part similarity metrics given explicitly alongside the 3D assets. The time required to generate assets is reduced by splitting the process into an online and offline stage. A ML retrieval model based on text and/or image input selects a template asset and candidate parts for generation. A ranking metric is formulated after generating variations from a shape synthesis module using part similarity metrics to rank generated assets. The ranking score closely matches the human perception. The metric can also be used to weed out defective assets generated without human intervention.

The present application relates generally to automated procedural generation of 3D assets through geometric variations using shape analysis and shape synthesis.

### BACKGROUND

Producing three dimensional (3D) assets for computer simulations such as computer games can be time-intensive. Moreover, even when machine learning (ML) is used to aid in asset generation, part segments (or part structure or both) must be manually labeled and given as input to the model. Such human-guided meta data, which can include part submeshes in 3D assets, scale, rotation and position of individual parts, part labels, etc.) are time-consuming to produce.

### SUMMARY

Present principles, in recognizing the above technical challenges, provide techniques to automatically generate 3D assets. A machine learning (ML) pipeline works solely on 3D assets without any meta data such as part labels or part structure or part similarity metrics given explicitly alongside the 3D assets. The time required to generate assets is reduced by splitting the process into an online and offline stage. A ML retrieval model based on text and/or image input selects a template asset and candidate parts for generation. A ranking metric is formulated after generating variations from a shape synthesis module using part similarity metrics to rank generated assets. The ranking score closely matches the human perception. The metric can also be used to weed out defective assets generated without human intervention.

Accordingly, in a first aspect a method includes automatically segmenting at least some assets into respective parts, with the assets including images of objects. The method includes calculating how the parts in the respective asset are hierarchically placed with respect to other parts in the respective asset and associating each part with a respective numerical descriptor that describes the respective part. The method further includes calculating a similarity metric for each part that describes the respective part's similarity to other part, and generating plural shape variations of at least one input asset using at least a first one of the parts with respective numerical descriptor and similarity matrix. Also, the method includes ranking at least some of the shape variations and outputting on at least one display images of the shape variations consistent the with ranking.

In some embodiments the automatically segmenting, calculating, associating, and calculating steps are pre-executed in an offline process. In contrast, the generating, ranking, and outputting are online stages executed in response to an input command for N variations of an asset selected from the library database.

In example implementations the method includes determining, for at least some of the parts, a context of the part relative to other parts in the respective asset and using the context in generating the shape variations.

If desired, the method may include maintaining contact points between adjacent parts in a respective asset to match in the shape generation.

In non-limiting examples the ranking includes using shape energy metrics in which higher shape energy values indicate higher plausibility of the respective shape variation.

The input can be text and/or image input.

In another aspect, a processor system is configured to execute a software-implemented parts segmenter on at least some assets in a database which include respective three dimensional (3D) images of objects, for producing segmented parts of the respective assets. For at least some of the segmented parts, the processor system generates a respective adjacency graph, at least one shape descriptor, and a similarity matrix. The adjacency graph represents a hierarchy of the part in the respective asset. The shape descriptor quantifies shape structure of the respective segmented part, and the similarity matrix represents a similarity of the respective part to other parts. The processor system is configured to receive a command to generate plural shape variations of an input and using the input, generate the plural shape variations at least in part based on some of the adjacency graphs, shape descriptors, and similarity matrices of respective parts. The system is further configured to rank at least some of the plural shape variations to establish a ranking and present on at least one display at least some of the shape variations according to the ranking.

In another aspect, a device includes at least one computer memory that is not a transitory signal and that includes instructions executable by at least one processor system to execute a machine learning (ML) pipeline on 3D assets to produce shape variations of the assets without any meta data including part labels, part structure, and part similarity metrics given explicitly alongside the 3D assets. The pipeline is executed in an offline stage and an offline stage. The offline stage includes, for at least some of the 3D assets, identifying individual parts of the respective 3D asset. The online stage includes receiving an input and based on the input, generating plural shape variations. The online stage also includes ranking at least some of the shape variations using part similarity metrics, and presenting at least some of the shape variations on a display consistent with the ranking.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 illustrates overall logic in example flow chart format for generating asset variations without any human guided meta data;

FIG. 3 illustrates a machine learning (ML) pipeline overview;

FIG. 4 illustrates pipeline output results using chairs as an example;

FIG. 5 illustrates various replacements using chairs;

FIG. 6 illustrates pipeline output results using tables as an example; and

FIG. 7 illustrates a use case scenario using variations of chairs.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single-or multi-chip processor that can execute logic by means of various lines such as address lines, data lines, and control lines and registers and shift registers. A processor including a digital signal processor (DSP) may be an embodiment of circuitry. A processor system may include one or more processors.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

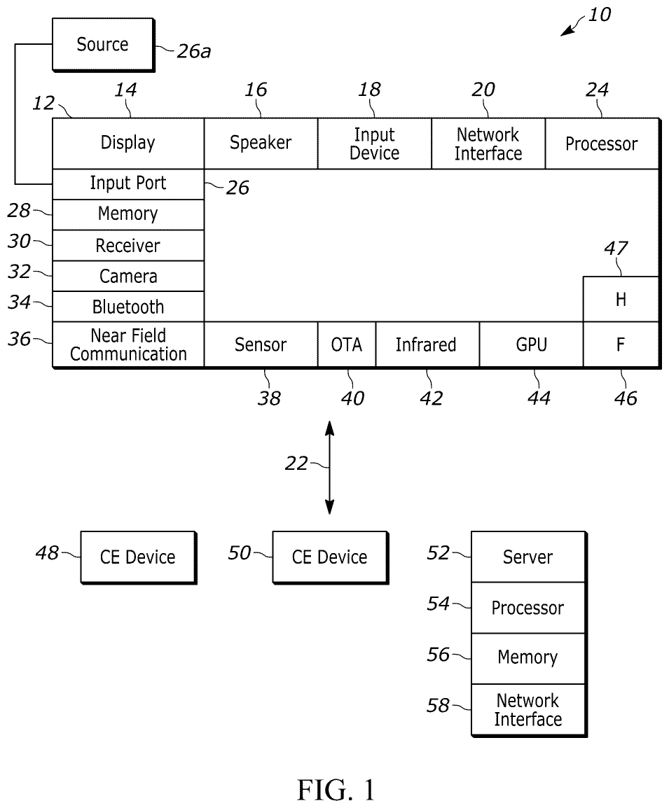

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom.

Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that are configured and weighted to make inferences about an appropriate output.

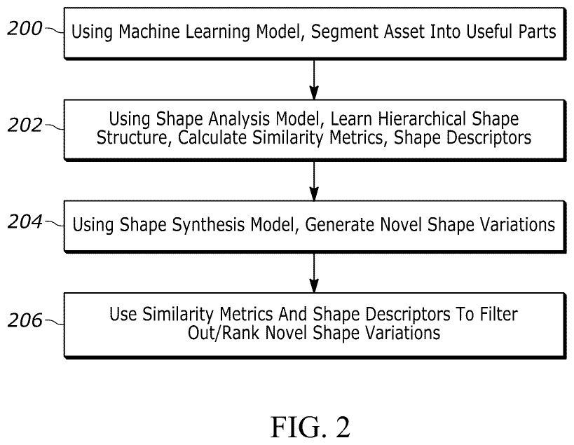

Refer now to FIG. 2, showing overall logic for generating asset variations without any human guided meta data which allows for faster iteration and quicker game development for artists. Commencing at state 200, a ML model is used to automatically segment an asset (e.g., from a library of assets) into useful parts/segments.

Proceeding to state 202, a shape analysis model is executed on the segments of the asset to learn shape structure by calculating how the parts in the 3D asset are hierarchically placed with respect other parts in the asset model. Each part identified at state 202 may be associated with a numerical descriptor that describes the part. Similarity metrics also are calculated for each part that describe the part's similarity to other parts. Thus, state 202 computes shape descriptors and similarity metrics of a given part with respect to all parts in the database. Similarity may be determined using cosine similarity and/or MSC distance similarity techniques, as an example. The context of the part such as a seat always being on top of legs of a chair, a seat being below the back of the chair, legs being below the seat, etc. also is determined, so that each node in the shape structure at state 202 represents a part, a neighbor node has an edge adjacent the node of a related part to maintain the hierarchical relationship between the individual parts.

States 200 and 202 may be a one time offline process that produces adjacent graphs that are maintained for recording asset class relationships.

After the completion of the shape analysis stage, at state 204 a shape synthesis model generates novel shape variations of the asset from states 200 and 202 using the information from shape analysis stage at state 202. Note further that important contact points between parts are constrained to match in the novel shape generation. In essence, the shape synthesis model calculates an oriented bounding box for 3D to decide what the shape of a novel shape variation should be.

At state 204, a template asset and candidate parts of the template asset are chosen either manually or picked using a ML retrieval model using text/image as input. Once the template asset and candidate parts are chosen, a graph shape structure and similarity metrics from state 202 are used to sample candidate part replacements for each part in the template asset. Once several candidate part replacements are chosen, part transforms (rotation, scale, and translation) are calculated for each candidate novel shape and a part composition stage replaces the existing part and places the new/incoming part into the template asset to generate 3D variations.

Moving to state 206, a shape/geometry-based ranking model is executed on the shape variations from state 204 which receives as input similarity metrics and shape descriptors to filter out defective assets and assign ranks to the generated shape variations (assets). Ranking the output (which may be tunable) helps the artist by using a similarity matrix from state 202 according to “shape energy” principles in which the higher the value, the more plausible the novel shape from state 204 is. The similarity between the input and novel shape can be calculated and then a combination of parts plus connected parts used to rank the shapes from state 204.

States 204 and 206 may be considered to be online stages in which, for example, an artist inputs a command for N variations of a vintage chair selected by the artist from a library database. The artist may also input an image of another chair the artist wants the library chair to resemble, or may input a text description of a desired look.

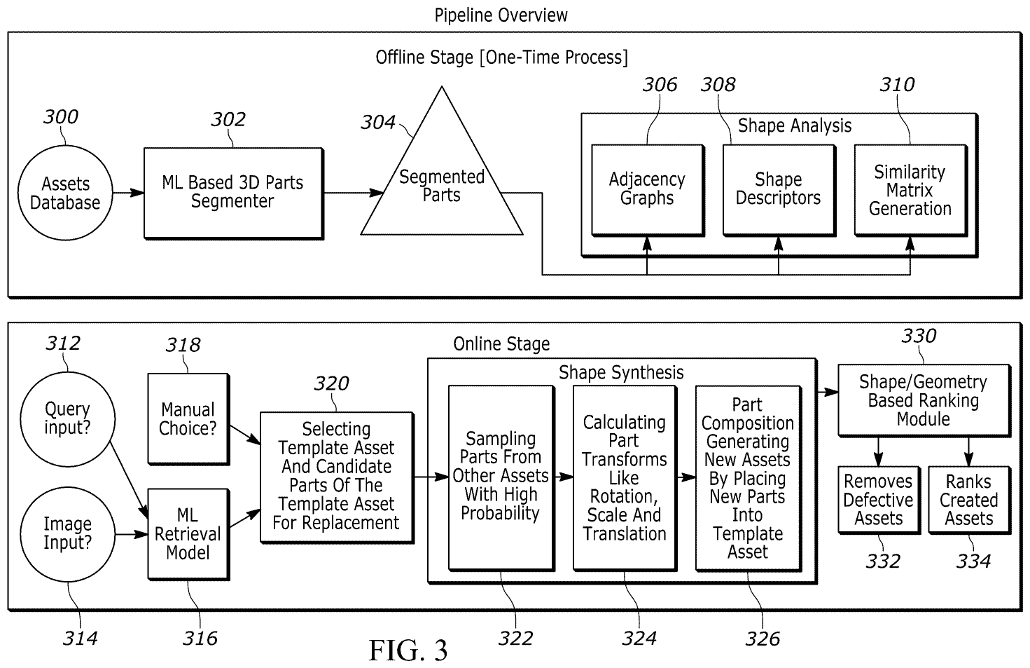

FIG. 3 illustrates the above pipeline. An assets database 300 feeds a parts segmenter ML model 302 for producing segmented parts 304, according to state 200 in FIG. 2.

State 202 in FIG. 2 is represented in FIG. 3 as receiving the segmented parts 304 and generating adjacency graphs 306, shape descriptors 308, and a similarity matrix generator 310. The shape descriptors 308 quantify the shape structure of parts segmented by the ML-based 3D parts segmenter 302. In one example, two types of shape descriptors may be used in the pipeline, namely, point-level descriptors and segment-level descriptors. The point-level descriptors represent the orientation of the surface of the parts of the 3D asset using normal of 3D points. The point-level descriptors also represent the distribution of points of the part in 3D space and capture (indicate) surface variations describing curvature variations established by the points in the segmented 3D part.

On the other hand, the segment-level descriptors determine the overall geometry of a 3D part by representing how linear or spherical or planar the shape of each 3D part is. The segment-level descriptors also represent the relative position of the 3D part in the overall shape of the asset.

The similarity matrix generator 310 receives as input a total of N parts (the output 304 of the 3D parts segmenter 302) from the asset database and generates a similarity matrix of shape N×N where “Similarity_Matrix[i][j]”=denotes similarity of part ‘i’ and part ‘j’. Part similarity can be measured by any of the 3D distance functions like cosine similarity or Earth Mover Distance or Mean Squared Error or Mean Absolute Error etc.

Having addressed the offline portion of the pipeline from 300-310, in an online state either a text query 312 and/or image input 314 from an artist is sent to a ML-based retrieval model 316 to retrieve one or more assets from a library that matches the input. A manual choice 318 of an asset also may be used. A selected template asset 320 is identified along with candidate parts for the asset to replace the corresponding parts from the input 316/318. The shape synthesis at state 204 in FIG. 2 is presented by a sampling of parts 322 from other assets in the library with a high probability of fitting the input asset. The above-described parts transforms are calculated by a transform module 324 and then new assets are generated by an asset generator 326 by placing the new parts into the template asset.

The ranking state 206 in FIG. 2 is represented by a shape/geometry based ranking module 328 which removes defective assets 330 and ranks the remaining assets 332 from best to worst. Ranking can be calculated by determining shape energy, which denotes the plausibility of a 3D shape. A higher shape energy denotes a higher plausibility (or believability or matches human acceptance criteria etc.) In an example, shape energy can be calculated by a combination of two terms. The first terms is a unary term, which is a metric calculated on an individual 3D part and which represents a similarity score between the original 3D part (in the template asset) and the replaced 3D part. Also, a pairwise term is a metric calculated based on the context of the 3D part in the overall shape. This is pairwise correspondence of the original 3D part (in the template asset) and the replaced 3D part with its neighboring parts. An artist may specify how many novel variations he wants returned, e.g., the top “N” ranked variations, wherein N is an integer.

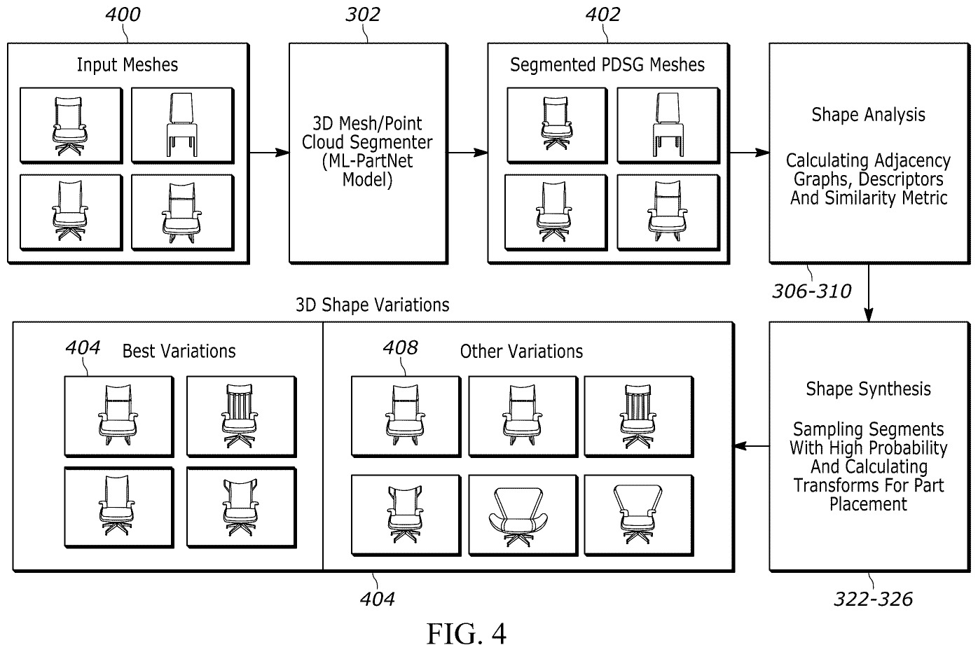

FIGS. 4-7 provide illustrations of output from the pipeline of FIGS. 2 and 3. In FIG. 4, as shown at 400 plural meshes, each representing an image of chair from a library, are input to the segmenter block 302 of FIG. 3. The segmenter block 302 outputs meshes 402 segmented into constituent parts, e.g., legs, seat, back. The parts are input to the shape analysis blocks 306-310 in FIG. 3 to complete the offline portion by constructing the shape descriptors and similarity matrices for the parts of the meshes.

Assuming an artist subsequently inputs an online command for generating various chairs based on an input image or text command, the shape synthesis blocks 322-326 in FIG. 3 sample the parts broken down by the shape analysis stage to output images 404 of various shape variations matching the input command. The images 404 may be sorted as shown in ranked order, with best variations 406 appearing on the left and other still suitable variations 408 appearing on the right, and with poor matches not being presented.

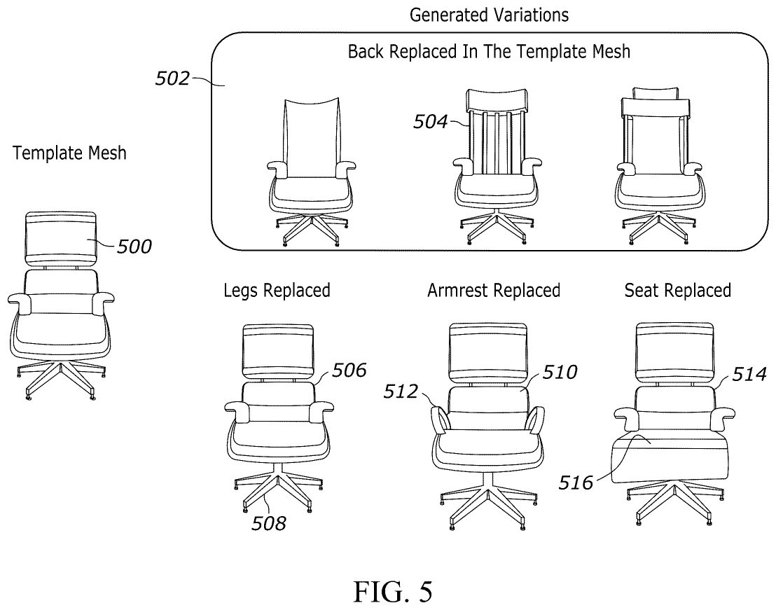

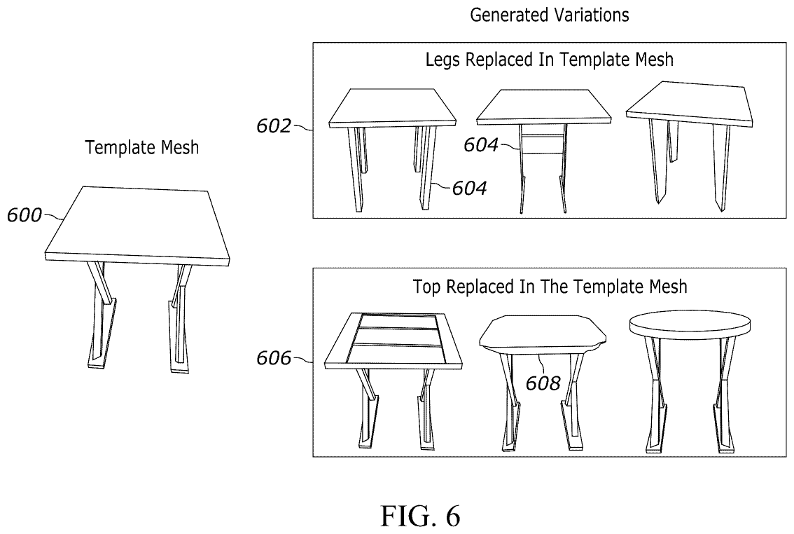

FIGS. 5 and 6 illustrate novel variations of chairs and tables, respectively. In FIG. 5, assume a chair-shaped template mesh 500 has been input by an artist for causing the pipeline to vary certain portions of the mesh. Images 502 are novel variations of the mesh 500 in which the back of the mesh 500 has been replaced by three respective back parts 504 from the parts segmenter. Image 506 illustrates novel variations 508 of the legs of the mesh, image 510 illustrates novel variations 512 of the armrests, and image 514 illustrates a novel variation 516 of the seat.

In FIG. 6, assume a table-shaped template mesh 600 has been input by an artist for causing the pipeline to vary certain portions of the mesh. Images 602 illustrate three respective novel variations 604 of the legs of the table while images 606 illustrate three respective novel variations 608 of the top of the table.

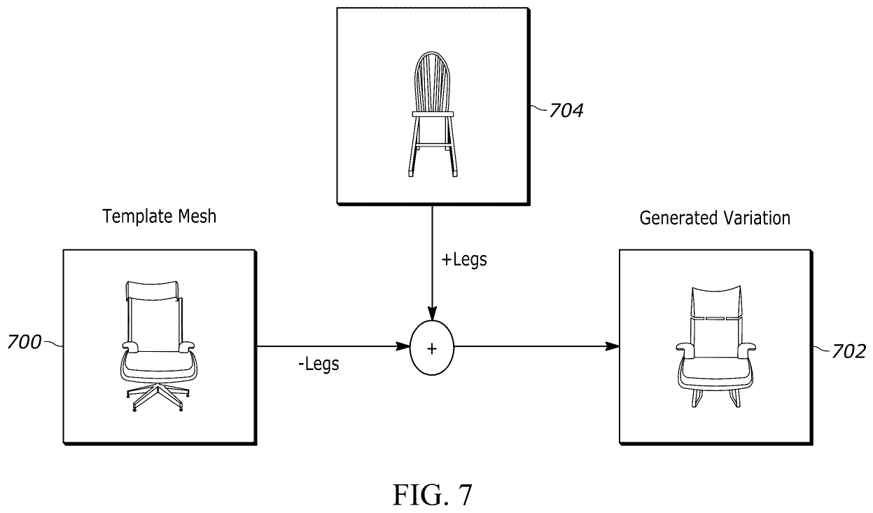

FIG. 7 illustrates another use case scenario in which it is to be assumed that an artist wishes to use a cool café chair 700 from a video game in a sequel of the video game, but not as-is. Assume that the artist likes a curved chair back and wants to see ten different variations of the model in which the legs and arms are swapped out (only one variation 702 shown, with legs from the leg parts of a generated chair 704 from the parts segmenter). The pipeline of FIG. 3 may be used to populate game environments with objects on scale using little time and to dynamically create 3D game content on the fly as the game switches from one game scene to another.

While the particular embodiments are herein shown and described in detail, it is to be understood that the subject matter which is encompassed by the present invention is limited only by the claims.

What is claimed is:

1. A method comprising:
automatically segmenting at least some assets into respective parts, the assets comprising images of objects;
calculating how the parts in the respective asset are hierarchically placed with respect other parts in the respective asset;
associating each part with a respective numerical descriptor that describes the respective part;
calculating a similarity metric for each part that describes the respective part's similarity to other parts;
generating plural shape variations of at least one input asset using at least a first one of the parts with respective numerical descriptor and similarity matrix;
ranking at least some of the shape variations; and
outputting on at least one display images of the shape variations consistent the with ranking.

2. The method of claim 1, wherein the automatically segmenting, calculating, associating, and calculating steps are pre-executed in an offline process.

3. The method of claim 1, comprising determining, for at least some of the parts, a context of the part relative to other parts in the respective asset and using the context in generating the shape variations.

4. The method of claim 1, comprising maintaining contact points between adjacent parts in a respective asset to match in the shape generation.

5. The method of claim 1, wherein the ranking comprises:
using shape energy metrics in which higher shape energy values indicate higher plausibility of the respective shape variation.

6. The method of claim 1, wherein the generating, ranking, and outputting are online stages executed in response to an input command for N variations of an asset selected from the library database.

7. The method of claim 6, wherein the input comprises an image.

8. The method of claim 6, wherein the input comprises text.

9. A processor system configured to:
execute a software-implemented parts segmenter on at least some assets in a database, the assets comprising respective three dimensional (3D) images of objects, for producing segmented parts of the respective assets;
for at least some of the segmented parts, generate a respective adjacency graph, at least one shape descriptor, and a similarity matrix, the adjacency graph representing a hierarchy of the part in the respective asset, the shape descriptor quantifying shape structure of the respective segmented part, the similarity matrix representing a similarity of the respective part to other parts;
receive a command to generate plural shape variations of an input;
using the input, generate the plural shape variations at least in part using some of the adjacency graphs, shape descriptors, and similarity matrices of respective parts;
rank at least some of the plural shape variations to establish a ranking; and
present on at least one display at least some of the shape variations according to the ranking.

10. The processor system of claim 9, wherein the input comprises text.

11. The processor system of claim 9, wherein the input comprises an image.

12. The processor system of claim 9, wherein the processor system is configured to:
rank at least some of the plural shape variations to establish a ranking at least in part by removing some shape variations and ranking remaining shape variations by determining shape energy.

13. The processor system of claim 12, wherein the processor system is configured to calculate the shape energy using a metric calculated on an individual part and which represents a similarity score between an original part and a replacement part.

14. The processor system of claim 13, wherein the processor system is configured to calculate the shape energy using a metric calculated based on a context of a part in an overall shape.

15. The processor system of claim 9, wherein the at least one shape descriptor comprises a point-level descriptor representing an orientation of a surface of the respective part.

16. The processor system of claim 15, wherein the point-level descriptor represents a distribution of points of the respective part in 3D space to indicate curvature variations of the respective part.

17. The processor system of claim 9, wherein the at least one shape descriptor comprises a segment-level descriptor representing an overall geometry of the respective part including how linear or spherical or planar a shape of the respective part is.

18. A device comprising:
at least one computer memory that is not a transitory signal and that includes instructions executable by at least one processor system to:
execute a machine learning (ML) pipeline on 3D assets to produce shape variations of the assets without any meta data including part labels, part structure, and part similarity metrics given explicitly alongside the 3D assets, the pipeline being executed in an offline stage and an offline stage, the offline stage comprising:
for at least some of the 3D assets, identifying individual parts of the respective 3D asset;
the online stage comprising:
receiving an input and based on the input, generating plural shape variations;
ranking at least some of the shape variations using part similarity metrics; and
presenting at least some of the shape variations on a display consistent with the ranking.

19. The device of claim 18, wherein the input comprises a text description of a 3D object.

20. The device of claim 18, wherein the input comprises in image of a 3D object.
